(19) United States
(12) Patent Application Publication
(10) Pub. No.: US 2016/0368120 A1
(43) Pub. Date: Dec. 22, 2016

(54) WRENCH

(71) Applicant: Milwaukee Electric Tool Corporation, Brookfield, WI (US)

(72) Inventors: Tauhira Hoossainy, Milwaukee, WI (US); Steven W. Hyma, Milwaukee, WI (US); Joseph M. DeBaker, Greenfield, WI (US)

(21) Appl. No.: 15/178,734

(22) Filed: Jun. 10, 2016

Related U.S. Application Data
(60) Provisional application No. 62/180,360, filed on Jun. 16, 2015.

(51) Int. Cl. B25B 13/14; B25B 23/16

(52) U.S. Cl. CPC B25B 13/14; B25B 23/16

(57) ABSTRACT

A wrench includes a handle and a head having a first jaw and a second jaw movable with respect to the first jaw. The second jaw includes a rack gear having a plurality of teeth. The wrench further includes an adjustment mechanism operable to move the second jaw with respect to the first jaw, and the adjustment mechanism includes a worm gear meshed with the rack gear. Each of the plurality of teeth includes a first side surface, a second side surface, and a top surface extending from the first side surface to the second side surface. The first side surface and the top surface define a first included angle, the second side surface and the top surface to define a second included angle, and the first and the second included angles are between 94 degrees and 100 degrees.

### CROSS-REFERENCE TO RELATED APPLICATIONS

This application claims priority to co-pending U.S. Provisional Patent Application No. 62/180,360 filed on Jun. 16, 2015, the entire content of which is incorporated herein by reference.

### BACKGROUND

The present invention relates to wrenches, and more particularly to adjustable wrenches.

Some types of conventional, adjustable wrenches include a fixed jaw and a movable jaw coupled to the fixed jaw by an adjustment mechanism. The adjustment mechanism of such an adjustable wrench can be manipulated to adjust the spacing between the fixed jaw and the movable jaw, allowing the wrench to accommodate a variety of differently sized fasteners. With many conventional wrenches, however, play or slop in the adjustment mechanism can alter the set spacing between the fixed jaw and the movable jaw. This necessitates time-consuming readjustment if a user desires to turn multiple fasteners of the same size.

### SUMMARY

In one embodiment, a wrench includes a handle and a head having a first jaw and a second jaw movable with respect to the first jaw. The second jaw includes a rack gear having a plurality of teeth. The wrench further includes an adjustment mechanism operable to move the second jaw with respect to the first jaw, and the adjustment mechanism includes a worm gear meshed with the rack gear. Each of the plurality of teeth includes a first side surface, a second side surface, and a top surface extending from the first side surface to the second side surface. The first side surface is oriented relative to the top surface to define a first included angle, the second side surface is orientated relative to the top surface to define a second included angle, and the first and the second included angles are each between 94 degrees and 100 degrees.

In another embodiment, a wrench includes a handle, a first jaw fixed to the handle, and a second jaw movable with respect to the first jaw. The second jaw includes a rack gear having a plurality of teeth. The wrench also includes an adjustment mechanism operable to move the second jaw with respect to the first jaw. The adjustment mechanism includes a worm gear meshed with the rack gear, the worm gear including a thread defining a first side surface, a second side surface, and a top surface that extends from the first side surface to the second side surface. The first side surface is oriented relative to the top surface to define first included angle, and the second side surface is oriented relative to the top surface to define a second included angle. The first and the second included angles are between 94 degrees and 100 degrees.

In another embodiment, a wrench includes an elongated handle including a first end portion, a second end portion opposite the first end portion, a cavity defined between the first and second end portions, and a wall extending along a longitudinal mid-plane of the cavity. The wrench also includes an insert at least partially disposed within the cavity, the insert including a first half and a second half positioned on opposite sides of the wall. The wrench further includes a head having a first jaw and a second jaw movable with respect to the first jaw. The second jaw includes a rack gear having a plurality of teeth. The wrench also includes an adjustment mechanism operable to move the second jaw with respect to the first jaw, the adjustment mechanism including a worm gear meshed with the rack gear.

Other features and aspects of the invention will become apparent by consideration of the following detailed description and accompanying drawings.

### BRIEF DESCRIPTION OF THE DRAWINGS

FIG. 1 is a perspective view of a wrench embodying aspects of the invention and including a handle insert.

FIG. 2 is a perspective view of the wrench of FIG. 1 with the handle insert removed.

FIG. 3 is a perspective view of a first portion of the handle insert of FIG. 1.

FIG. 4 is a perspective view of a second portion of the handle insert of FIG. 1.

FIG. 5 is a cross sectional view taken along 5-5 of FIG. 1 with the handle insert coupled to a handle portion of the wrench.

FIG. 6 is a cross sectional view taken along 6-6 of FIG. 1 illustrating an adjustment mechanism of the wrench.

FIG. 7 is a detailed view of the adjustment mechanism of FIG. 6.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

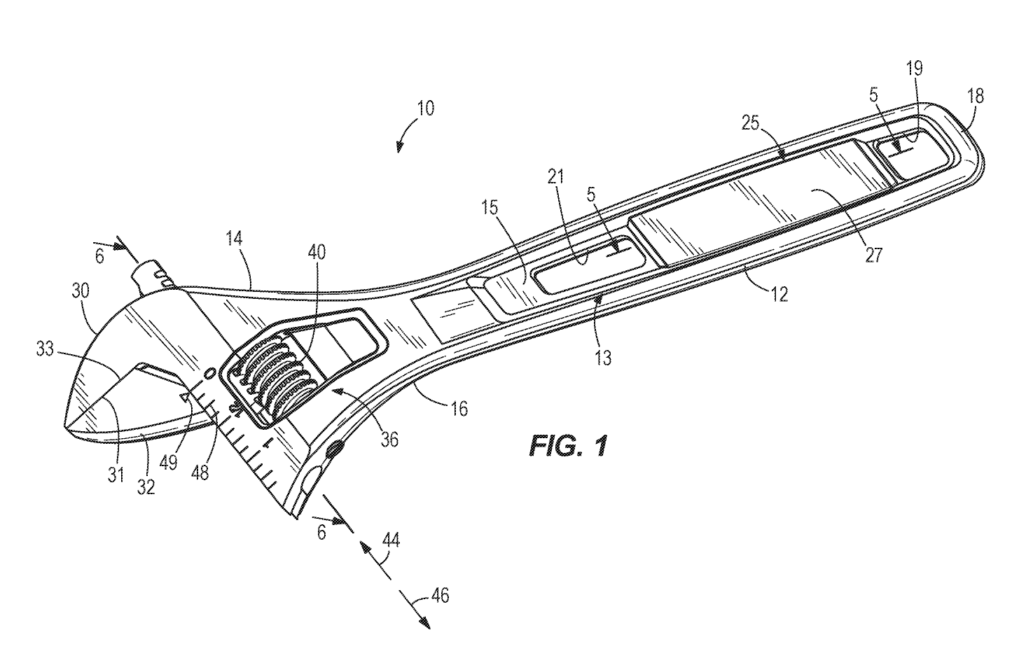

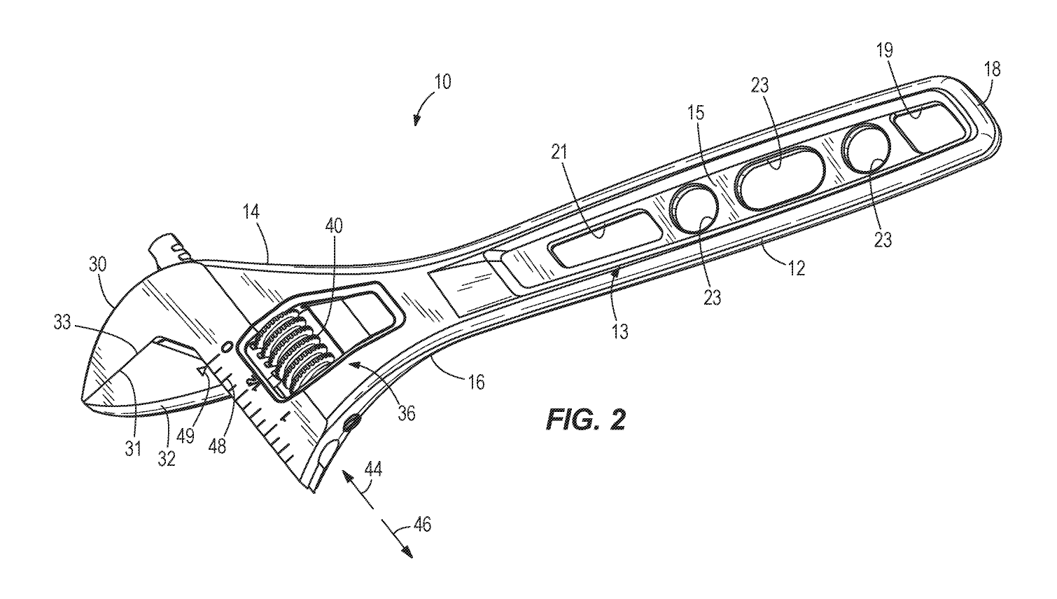

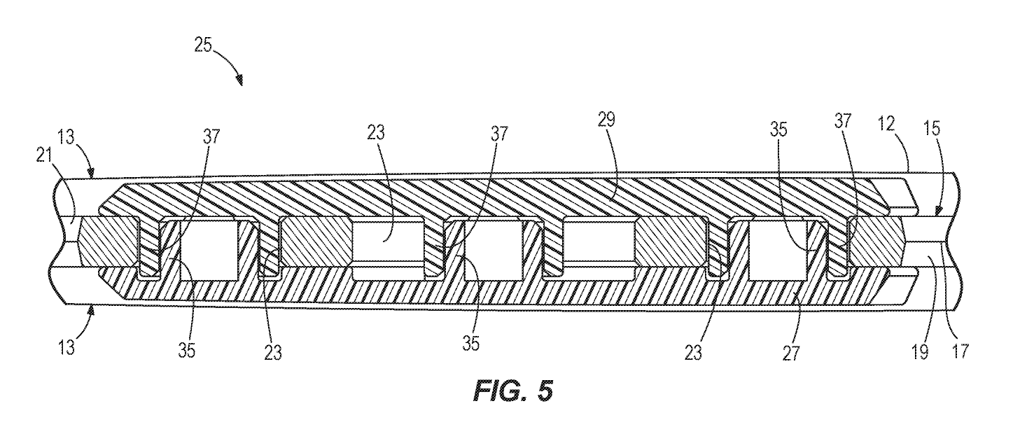

FIG. 1 illustrates a wrench 10. The wrench 10 includes a handle 12 and a head 14. The handle 12 is elongated and has a front end portion 16 and a rear end portion 18 with a cavity 13 positioned therebetween. With reference to FIG. 2, a wall 15 separates the cavity 13 into two portions (e.g., a cross section of the handle 12 through the wall 15 and between portions 16, 18 is shaped as an I-beam). In the illustrated embodiment, the wall 15 extends along a longitudinal mid-plane 17 of the handle 12 (FIG. 5) and includes a first aperture 19, a second aperture 21, and a series of third apertures 23 (FIG. 2). The first aperture 19 is located at the rear end portion 18 and provides a location for hanging the wrench 10 (e.g., for storage purposes). The series of third apertures 23 are positioned between the first aperture 19 and the second aperture 21. The cavity 13 along with each of the apertures 19, 21, 23 provide a light-weight design without compromising structural integrity of the wrench 10.

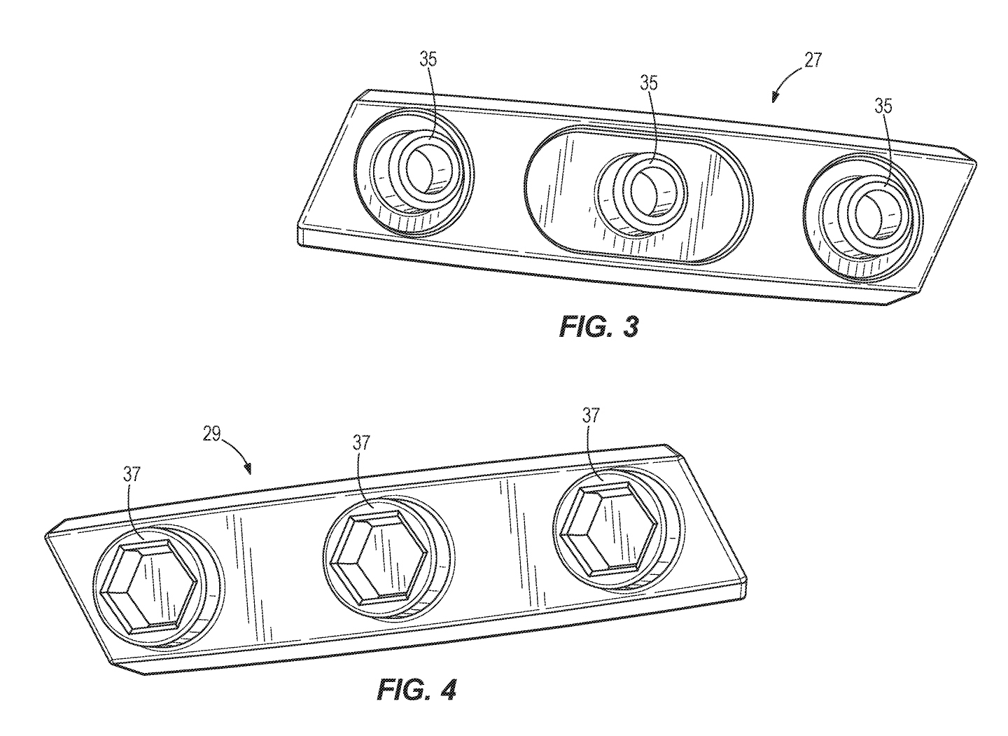

The handle 12 further includes a handle insert 25 positioned within the cavity 13 and between the first and the second apertures 19, 21. The illustrated handle insert 25 includes a first portion or half 27 (FIG. 3) and a second portion or half 29 (FIG. 4) coupled to opposite sides of the wall 15. In particular, the first portion 27 includes protrusions 35 that are sized to engage within corresponding projections 37 located on the second portion 29. The illustrated protrusions 35 are formed as three, hollow, cylindrical members, each with a tapered end; however, in other embodiments the protrusions 35 may be solid members. In further embodiments, the geometry of the protrusions 35 may be different, (e.g., cube, hemisphere, etc.) and/or the first portion 27 may include greater than or fewer than three protrusions 35. In the illustrated embodiment, the projections 37 include hexagonal-shaped hollow interiors; however, in other embodiments, the interior portion of the projections 37 may include other geometries, such as geometry similar to the exterior geometry of the protrusions 35. Additionally, the second portion 29 of the insert 25 may include greater than or fewer than three projections 37.

With reference to FIG. 5, each respective pair of protrusions 35 and projections 37 extend through a corresponding third aperture 23. In the illustrated embodiment, greater clearance is provided between a middle third aperture 23 and the middle projection 37 compared to outer third apertures 23 and the corresponding projections 37. The illustrated first portion 27 and the second portion 29 are press fit (e.g., clearance fit) together. In other embodiments, an adhesive may be also utilized to secure the protrusions 35 within the projections 37. Once the handle insert 25 is assembled to the wall 15, an outer surface of the portions 27, 29 that face away from the wall 15 are generally flush or coextensive with the handle 12 (FIG. 5). In other words, the portions 27, 29 include a thickness generally extending the depth of the cavity 13.

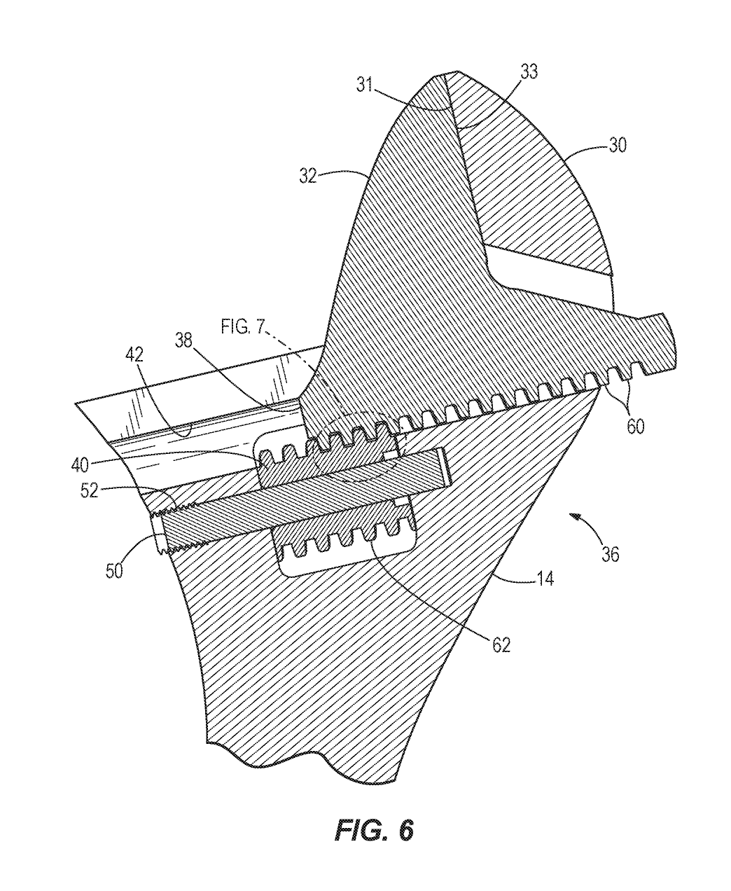

With reference to FIGS. 1 and 6, the head 14 includes a first or fixed jaw 30 having a contact surface 31 and a second or movable jaw 32 having a contact surface 33. In the illustrated embodiment, the contact surface 31 extends generally parallel to the contact surface 33. In some embodiments, the contact surfaces 31, 33 may include teeth configured to grip a work piece. The head 14 further includes an adjustment mechanism 36, which is a worm drive in the illustrated embodiment. The worm drive 36 includes a rack gear 38 and a worm gear 40.

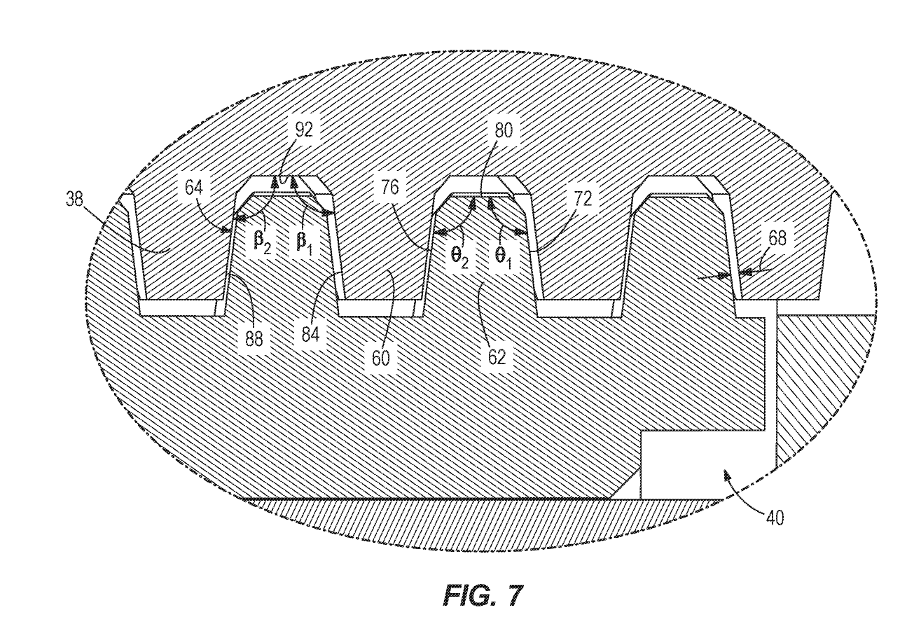

The illustrated worm gear 40 includes a single thread 62. With reference to FIG. 7, the thread 62 includes a first side surface 72, a second side surface 76, and a top surface 80. The top surface 80 extends from the first side surface 72 to the second side surface 76 and faces the rack gear 38. The first side surface 72 is oriented relative to the top surface 80 at a first included angle θ₁. Likewise, the second side surface 76 is oriented relative to the top surface 80 at a second included angle θ₂. The illustrated first and second angles θ_{1,2} are about 97 degrees (i.e., a draft angle of 7 degrees). In other embodiments, the first and the second angles θ_{1,2} may vary from 94 degrees to 100 degrees. The illustrated angles θ_{1,2} are both about 97 degrees; however, in other embodiments the angles θ_{1,2} may not be equal. The illustrated thread 62 includes a pitch of about 3.5 millimeters. In other embodiments, the thread 62 may include a pitch of about 2.5 millimeters. In other embodiments, the worm gear 40 may be a double-lead worm gear including two threads. The worm gear 40 is rotatably coupled to the head 14 via a pin 50 and the worm gear 40 rotates about the pin 50 and meshes with the rack gear 38 to move the jaw 32 in the direction of arrows 44 and 46 (FIG. 1) relative to the fixed jaw 30. The pin 50 includes a threaded portion 52. The threaded portion 52 couples the pin 50 to the head 14. In some embodiments, the pin 50 may be swaged and the threaded portion 52 omitted.

With reference to FIGS. 6 and 7, the rack gear 38 includes a plurality of teeth 60 and is fixed to the movable jaw 32 for movement with the movable jaw 32 relative to the fixed jaw 30. Regions between each of the plurality of teeth 60 are defined by a profile 64. The illustrated profile 64 includes a first side surface 84, a second side surface 88, and a top surface 92. The top surface 92 extends from first side surface 84 to the second side surface 88 and faces the worm gear 40. The first side surface 84 is oriented relative to the top surface 92 at a third included angle β₁. Likewise, the second side surface 88 is oriented relative to the top surface 92 at a fourth included angle β₂. The illustrated third and fourth angles β_{1,2} are about 97 degrees (i.e., a draft angle of 7 degrees). In other embodiments, the third and fourth angles β_{1,2} may vary from 94 to 100 degrees. The illustrated angles β_{1,2} are both about 97 degrees; however, in other embodiments, the angles β_{1,2} may not be equal.

The rack gear 38 is received in a generally cylindrical aperture 42 of the head 14 (FIG. 6). The aperture 42 guides the generally cylindrical rack gear 38 to guide movement of the jaw 32 so that the jaw 32 moves parallel to the arrows 44 and 46 in FIG. 1. In the illustrated embodiment, the fixed jaw 30 includes indicia 48 in the form of a measurement scale. The movable jaw 32 includes an indicator 49 that aligns with the indicia 48 to provide an indication of the spacing between the contact surfaces 31, 33. Accordingly, the jaws 30, 32 may be quickly and accurately adjusted to accommodate differently sized fasteners, without requiring trial and error.

The worm drive 36 is dependent upon the engagement between the rack gear 38 and the worm gear 40 to move the moveable jaw 32 in the direction of the arrows 44 and 46. As a result, it is advantageous to decrease the amount of mechanical backlash 68 (FIG. 7) between the rack gear 38 and the worm gear 40. In particular, mechanical backlash 68 is the clearance (e.g., distance) between the thread 62 and the teeth 60 that creates a degree of play or loss of motion before the thread 62 engages the teeth 60. For example, if there is not enough mechanical backlash, the thread 62 and the teeth 60 will seize and operation of the worm drive 36 will be compromised. In contrast, if there is too much mechanical backlash, there will an undesirable amount of play or loss of motion between the thread 62 and the teeth 60. The thread construction of the thread 62 engaging the profile 64 provides adequate amount of mechanical backlash 68 yielding smooth operation of the wrench 10.

In operation, the user can use the wrench 10 to turn a fastener (not shown), such as a hex head nut, a bolt, and the like. The user first rotates the worm gear 40 to adjust the spacing between the jaws 30 and 32 (i.e., the perpendicular distance between contact surfaces 31 and 33 of the jaws 30 and 32). As the user rotates the worm gear 40, the meshing between the worm gear 40 and the rack gear 38 causes the movable jaw 32 to move in the direction of either arrow 44 or 46 (FIG. 1), depending on which direction the worm gear 40 is rotated. In the illustrated embodiment, a maximum of six profiles 64 of the teeth 60 engage the thread 62; however, in other embodiments, the number of profiles 64 that engage the thread 62 may be greater or less than six. The user adjusts the spacing so that the spacing is slightly larger than a distance between opposite sides of the fastener. The user may adjust the spacing by relying upon the indicator 49 and the indicia 48. Alternatively, the user may adjust the spacing with the fastener already inserted between the contact surface 31 and 33 by rotating the worm gear 40 until the contact surfaces 31 and 33 contact the fastener. Once the spacing is properly set, the user may rotate the wrench 10 to turn the fastener.

Various features of the invention are set forth in the following claims.

What is claimed is:

1. A wrench comprising:
a handle;
a head including a first jaw and a second jaw movable with respect to the first jaw, the second jaw including a rack gear having a plurality of teeth; and
an adjustment mechanism operable to move the second jaw with respect to the first jaw, the adjustment mechanism including a worm gear meshed with the rack gear,
wherein each of the plurality of teeth includes a first side surface, a second side surface, and a top surface extending from the first side surface to the second side surface, and
wherein the first side surface is oriented relative to the top surface to define a first included angle, the second side surface is orientated relative to the top surface to define a second included angle, and the first and the second included angles are between 94 degrees and 100 degrees.

2. The wrench of claim 1, wherein the first and second included angles are about 97 degrees.

3. The wrench of claim 1, wherein the worm gear includes a thread defining a first side surface, a second side surface, and a top surface extending from the first side surface to the second side surface.

4. The wrench of claim 3, wherein the first side surface and the top surface of the thread define a third included angle between 94 degrees and 100 degrees, and wherein the second side surface and the top surface define a fourth included angle between 94 degrees and 100 degrees.

5. The wrench of claim 4, wherein the third included angle is about 97 degrees.

6. The wrench of claim 4, wherein the fourth included angle is about 97 degrees.

7. The wrench of claim 3, wherein the thread includes a pitch of about 3.5 millimeters.

8. The wrench of claim 3, wherein the thread includes a pitch of about 2.5 millimeters.

9. The wrench of claim 1, wherein the worm gear is a double lead worm gear.

10. The wrench of claim 1, wherein the head includes a generally cylindrical aperture, and wherein the rack gear is at least partially received within the cylindrical aperture such that the rack gear slides within the cylindrical aperture to adjust the distance between the first jaw and the second jaw.

11. The wrench of claim 1, wherein the handle includes a cavity and a wall extending along a longitudinal mid-plane of the cavity.

12. The wrench of claim 11, further comprising an insert at least partially disposed within the cavity, the insert including a first half and a second half positioned on opposite sides of the wall.

13. A wrench comprising:
a handle;
a first jaw fixed to the handle;
a second jaw movable with respect to the first jaw, the second jaw including a rack gear having a plurality of teeth; and
an adjustment mechanism operable to move the second jaw with respect to the first jaw, the adjustment mechanism including a worm gear meshed with the rack gear, the worm gear including a thread defining a first side surface, a second side surface, and a top surface that extends from the first side surface to the second side surface, and
wherein the first side surface is oriented relative to the top surface to define first included angle, and the second side surface is oriented relative to the top surface to define a second included angle, and
wherein the first and the second included angles are between 94 degrees and 100 degrees.

14. The wrench of claim 13, wherein the first and second included angles are about 97 degrees.

15. The wrench of claim 13, wherein the thread includes a pitch of about 3.5 millimeters.

16. The wrench of claim 13, wherein the thread includes a pitch of about 2.5 millimeters.

17. A wrench comprising:
an elongated handle including a first end portion, a second end portion opposite the first end portion, a cavity defined between the first and second end portions, and a wall extending along a longitudinal mid-plane of the cavity;
an insert at least partially disposed within the cavity, the insert including a first half and a second half positioned on opposite sides of the wall;
a head including a first jaw and a second jaw movable with respect to the first jaw, the second jaw including a rack gear having a plurality of teeth; and
an adjustment mechanism operable to move the second jaw with respect to the first jaw, the adjustment mechanism including a worm gear meshed with the rack gear.

18. The wrench of claim 17,
wherein the worm gear includes a thread defining a first side surface, a second side surface, and a top surface that extends from the first side surface to the second side surface,
wherein the first side surface is oriented relative to the top surface to define first included angle, and the second side surface is oriented relative to the top surface to define a second included angle, and
wherein the first and the second included angles are between 94 degrees and 100 degrees.

19. The wrench of claim 17, wherein the wall includes a plurality of apertures.

20. The wrench of claim 17, wherein one of the first half and the second half of the insert includes a plurality of protrusions engaged with a corresponding plurality of projections on the other of the first half and the second half to couple the first and second halves together.
